(19) United States
(12) Patent Application Publication
(10) Pub. No.: US 2023/0407610 A1
(43) Pub. Date: Dec. 21, 2023

(54) DUAL SENSOR FOR HYDRANT

(71) Applicant: Mueller International, LLC, Atlanta, GA (US)

(72) Inventors: Yanlong Li, Hixson, TN (US); Haedoo Choi, Sandy Springs, GA (US); Emil Simion, Smyrna, GA (US); Christopher Joseph Duckett, Guntersville, AL (US); Justin Blaine Childress, Albertville, AL (US); Diego Aguilera, Chattanooga, TN (US); Jason Cole Eason, Albertville, AL (US)

(21) Appl. No.: 18/208,106

(22) Filed: Jun. 9, 2023

Related U.S. Application Data
(60) Provisional application No. 63/351,232, filed on Jun. 10, 2022.

(51) Int. Cl. E03B 9/04; G01L 19/08; G01L 19/00

(52) U.S. Cl. CPC E03B 9/04; G01L 19/0038; G01L 19/086

(57) ABSTRACT

A sensing device for a hydrant in a fluid distribution system configured to transport a fluid can include a housing defining a portion of an operating stem of the hydrant; a vein connected to the housing, the vein defining a channel; and a sensor received at least partly and within the channel of the vein and configured to measure at least two properties of the fluid.

### REFERENCE TO RELATED APPLICATIONS

This application claims the benefit of U.S. Provisional Application No. 63/351,232, filed Jun. 10, 2022, which is hereby specifically incorporated by reference herein in its entirety.

### TECHNICAL FIELD

### Field of Use

This disclosure relates to fire hydrants. More specifically, this disclosure relates to hydrants able to collect and relay system data.

### Related Art

Proper maintenance of a water system can be facilitated by knowledge about each aspect of the system—particularly knowledge regarding water pressure and other characteristics of flow in the line. In the field, placing sensors can be difficult and can incur significant expense, affect the data being measured, and/or take equipment useful for public safety out of temporary service.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a sensing device for a hydrant for a fluid distribution system, the hydrant comprising: a hydrant body defining an interior cavity; a valve located in sealable communication with the hydrant body, the interior cavity in fluid communication with a shoe cavity of the system when the valve is open, the valve configured to seal the interior cavity of the hydrant from the shoe cavity when the valve is closed; a stem secured to the valve, positioned at least partly inside the interior cavity of the hydrant, the stem configured to open and close the valve, the stem comprising a vein defining a channel extending from a lower end of the vein to an upper end of the vein; and a sensing device comprising: a sensor located within the interior cavity of the hydrant body and configured to measure at least two characteristics of a fluid of the fluid distribution system; and at least one battery in communication with the sensor.

In a further aspect, disclosed is a sensing device for a hydrant in a fluid distribution system configured to transport a fluid, the sensing device comprising: a housing defining a portion of an operating stem of the hydrant; a vein connected to the housing, the vein defining a channel; and a sensor received at least partly and within the channel of the vein and configured to measure at least two properties of the fluid.

In yet another aspect, disclosed is a sensor assembly comprising: a housing; a pressure sensor coupled to the housing; a temperature sensor coupled to the housing; and an antenna in communication with the sensor and positioned within the housing.

In yet another aspect, disclosed is a method comprising: measuring a first characteristic of a fluid inside a hydrant of a fluid distribution system with a sensing device, the sensing device comprising: a vein defining a channel; and a sensor comprising: a first sensing element received at least partly within the channel of the vein; a second sensing element received at least partly within the channel of the vein; and at least one battery in communication with the sensor; and measuring a second characteristic of the fluid with the sensing device; and transmitting data corresponding to the first characteristic and the second characteristic of the fluid from the sensor to the antenna.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and together with the description, serve to explain various principles of the disclosure. The drawings are not necessarily drawn to scale. Corresponding features and components throughout the figures may be designated by matching reference characters for the sake of consistency and clarity.

FIG. 1 is a side view of a hydrant in accordance with one aspect of the current disclosure.

FIG. 2A is a sectional view of the hydrant of FIG. 1 taken along line 2A-2A of FIG. 1.

FIG. 2B is a sectional view of the hydrant of FIG. 1 taken along line 2B-2B of FIG. 2A and comprising a sensing device positioned inside a stem of the hydrant.

FIG. 3 is a bottom perspective view of a vein of a lower stem bottom end of an operating stem of the hydrant of FIG. 1 in an assembled condition.

FIG. 4 is a bottom perspective view of the lower stem bottom end of FIG. 3 in an exploded or disassembled condition.

FIG. 5A is a detail sectional view of the hydrant of FIG. 1 taken from detail 5A of FIG. 2A showing the lower stem bottom end of FIG. 3 as well as a main valve assembly or valve of the hydrant in accordance with another aspect of the current disclosure.

FIG. 5B is a detail sectional view of the hydrant of FIG. 1 taken along line 5B-5B of FIG. 2B showing the lower stem bottom end of FIG. 3 as well as a main valve assembly or valve of the hydrant in accordance with another aspect of the current disclosure shown also in FIG. 2B.

FIG. 5C is a detail sectional view of a bottom end of the lower stem bottom end of the hydrant of FIG. 1 taken from detail 5C of FIG. 5B.

FIG. 6A is a bottom perspective view of a lower stem top end of the operating stem of the hydrant of FIG. 1 in an assembled condition.

FIG. 6B is a bottom perspective view of the lower stem top end of the operating stem of the hydrant of FIG. 1 in an assembled condition in accordance with another aspect of the current disclosure shown also in FIG. 2B.

FIG. 7A is a bottom exploded perspective view of the lower stem top end of FIG. 6A in a disassembled condition.

FIG. 7B is a bottom exploded perspective view of the lower stem top end of FIG. 6B in a disassembled condition in accordance with another aspect of the current disclosure shown also in FIG. 2B.

FIG. 7C is a sectional view of the lower stem top end of FIG. 6B taken along line 7C-7C of FIG. 6B and, alternatively, detail 7C of FIG. 8B.

FIG. 8A is a detail sectional view of the hydrant of FIG. 1 taken from detail 8 of FIG. 2A showing the lower stem top end of FIG. 6A and surrounding structure of the sensing device of FIG. 2B.

FIG. 8B is a detail sectional view of the hydrant of FIG. 1 taken from detail 8 of FIG. 2A showing the lower stem top end of FIG. 6B and surrounding structure of the sensing device of FIG. 2B.

FIG. 9 is a side perspective view of a stem of the hydrant of FIG. 1 extending from an operating nut of the hydrant of FIG. 1 and showing also the lower stem top end of the operating stem of the hydrant of FIG. 1 as well as a connection therebetween.

FIG. 10 is a sectional view of the operating stem of FIGS. 3, 4, 6A, and 7A taken along line 10-10 of FIG. 2A and in accordance with another aspect of the current disclosure.

FIG. 11 is a detail sectional view of the lower stem top end of the operating stem of FIG. 10 taken along line 11-11 of FIG. 2A and, alternatively, detail 11 of FIG. 10.

FIG. 12 is a detail sectional view of the lower stem bottom end of the operating stem of FIG. 10 taken along line 12-12 of FIG. 2A and, alternatively, detail 12 of FIG. 10.

FIG. 13 is a side view of a sensor of the sensing device of FIG. 2B in accordance with another aspect of the current disclosure.

FIG. 14A is a side perspective view of the sensor of the sensing device of FIG. 2B in accordance with another aspect of the current disclosure.

FIG. 14B is a side view of the sensor of FIG. 14A in accordance with another aspect of the current disclosure.

FIG. 14C is a sectional view of the sensor of FIG. 14A taken along line 14C-14C of FIG. 14B (and not showing the internal components or other structure).

FIG. 14D is a detail sectional view of the sensor of FIG. 14A taken from detail 14D of FIG. 14C.

FIG. 14E is an end view or bottom view of the sensor of FIG. 14A.

FIG. 15A is a side perspective view of the sensor of the sensing device of FIG. 2B in accordance with another aspect of the current disclosure.

FIG. 15B is a side perspective view of the operating stem and, more specifically, the lower stem bottom end of FIG. 3 in accordance with another aspect of the current disclosure.

FIG. 15C is a side perspective view of the sensing device of FIG. 15A assembled to the lower stem bottom end of FIG. 15B.

FIG. 15D is an end perspective view or bottom perspective view of the assembly of FIG. 15C.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” and the phrase “one or more of A and B” as used herein mean “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the hydrant nearest to a main nozzle; “rear” is that end of the hydrant that is opposite or distal the front; “left” is that which is to the left of or facing left from a person facing towards the front; and “right” is that which is to the right of or facing right from that same person facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

In one aspect, a hydrant and associated methods, systems, devices, and various apparatuses are disclosed herein. In various aspects, the hydrant can comprise a sensing device and, more specifically, a sensing assembly comprising two sensors for measuring at least two parameters of a system comprising the hydrant. In various aspects, the hydrant can comprise a communications hub in wireless communication with the sensing device and with a network. It would be understood by one of skill in the art that the disclosed hydrant is described in but a few exemplary aspects among many. No particular terminology or description should be considered limiting on the disclosure or the scope of any claims issuing therefrom.

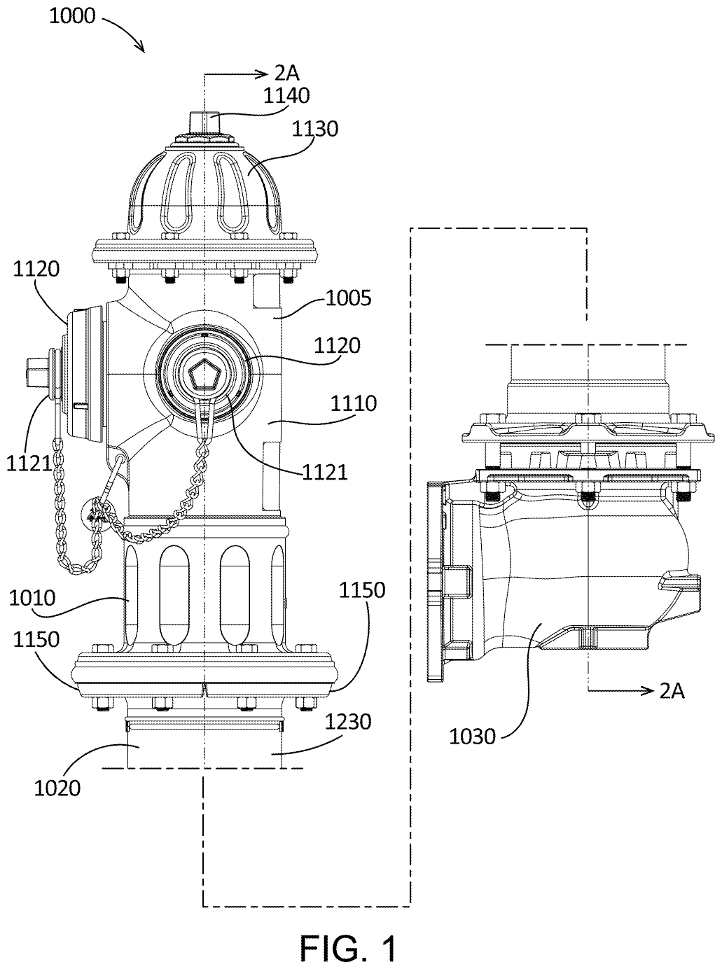

FIG. 1 is a side view of a hydrant 1000 in accordance with one aspect of the current disclosure. A fluid distribution system such as, for example and without limitation, a municipal water system, can comprise the hydrant 1000, which can be a fire hydrant. As shown, the hydrant 1000 can comprise a hydrant body 1005, which can comprise an upper barrel assembly 1010, a lower barrel assembly 1020, and a shoe 1030. In various aspects, the upper barrel assembly 1010 of the hydrant 1000 can be positioned above ground, the lower barrel assembly 1020 can be at least partially subterranean, and the shoe 1030 can be connected to the fluid distribution system and can be installed in the ground.

The upper barrel assembly 1010 can comprise an upper barrel 1110, one or more nozzles 1120, one or more nozzle caps 1121, and a bonnet 1130. The one or more nozzles 1120 can be configured to connect fire hoses or other equipment. The nozzle caps 1121 can cover the corresponding nozzles 1120 and can be adapted or configured to be removable to provide selective access to the nozzles 1120. The bonnet 1130, from which an operating nut 1140 can extend, can be secured to the upper barrel 1110. As shown, the bonnet 1130 can be attached to the upper barrel 1110 by bolts. The upper barrel assembly 1010 can be connected or attached to the lower barrel assembly 1020, which can be with bolts. Such bolts can connect the upper barrel assembly 1010 to the lower barrel assembly 1020 through a traffic flange 1150, which can be frangible. The lower barrel assembly 1020 can comprise a lower barrel 1230.

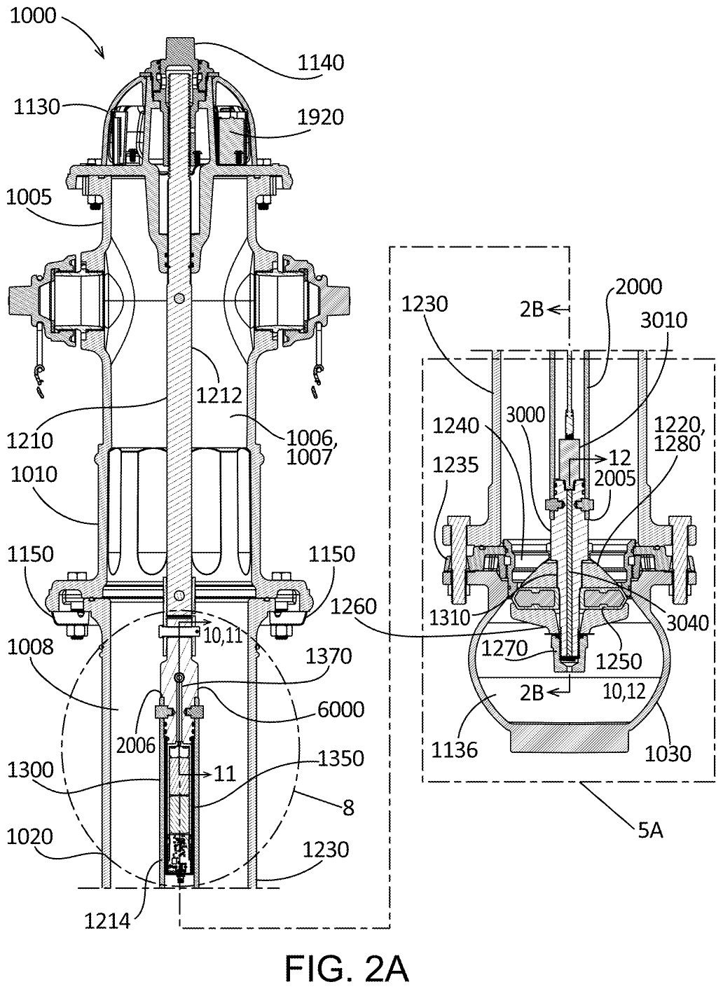

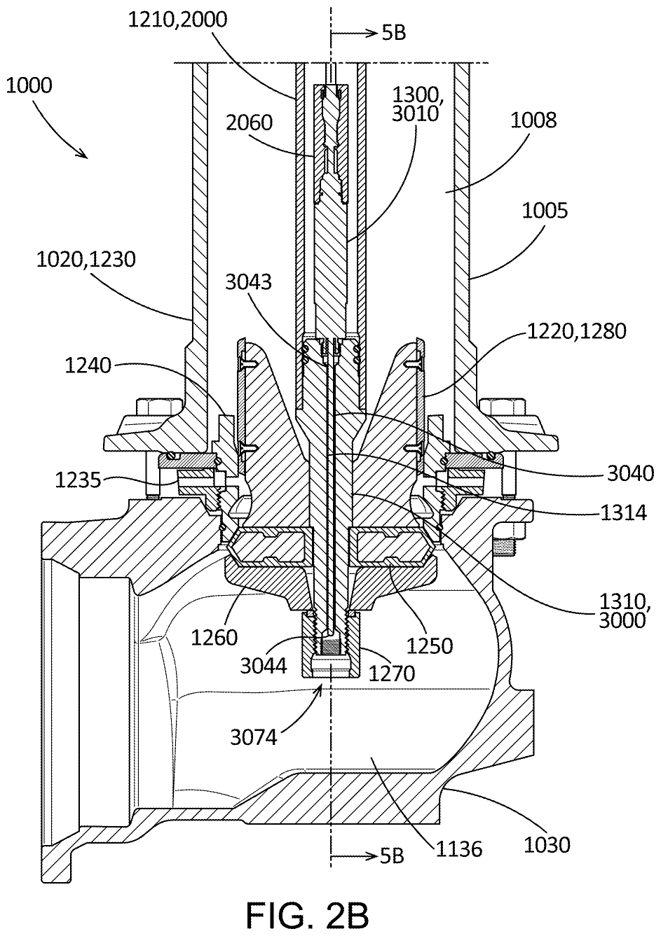

FIG. 2A is a sectional view of the hydrant 1000 of FIG. 1 taken along line 2A-2A of FIG. 1. The hydrant body 1005 can define an interior cavity 1006. More specifically, the upper barrel assembly 1010 can define an upper portion 1007 of the interior cavity 1006; and the lower barrel assembly 1020 can define a lower portion 1008 of the interior cavity 1006. The shoe 1030 can define a shoe cavity 1136. A spacer 1235 can be positioned between the lower barrel 1230 and the shoe 1030.

An operating stem 1210 can be positioned within the hydrant 1000 and can extend from the bonnet 1130 to a valve 1220 (shown in FIG. 2B), which can be a valve assembly and can be positioned proximate to or at a junction between the shoe 1030 and the lower barrel assembly 1020. The operating stem 1210 can extend through each of the bonnet 1130 and the valve 1220. The operating stem 1210 can be actuated by the operating nut 1140 at a top end of the bonnet 1130. More specifically, the operating stem 1210 can be configured to open and close the valve upon rotation of the operating nut 1140 about a stem axis defined by the operating stem 1210. The interior cavity 1006 of the hydrant 1000 can be in fluid communication with the shoe cavity 1136 when the valve 1220 is open, and the valve 1220 can be configured to seal the interior cavity 1006 from the shoe cavity 1136 when the valve 1220 is closed.

The valve 1220 can comprise one or more components. More specifically, the valve 1220 can comprise a valve member 1250. The valve member 1250 can comprise a rigid or semi-rigid disc. The valve member 1250 can be encapsulated in a flexible material or other covering or coating. In various aspects, the valve member 1250 can be coated in a sealing material such as rubber or elastomer. When the valve 1220 is closed, the valve member 1250 can seal against a valve seat 1240, thereby preventing water from ascending into or otherwise entering the lower barrel 1230. The valve 1220 can comprise a valve retainer 1260, which can be located adjacent to and below a first end or bottom end of the valve member 1250. More specifically, the valve retainer 1260 can push or press the valve member 1250 against the valve seat 1240. A valve nut 1270 can be attached or connected to an end of the operating stem 1210 to secure the valve member 1250 and the valve retainer 1260 to the operating stem 1210 and to push or press the valve retainer 1260 against the valve member 1250. A reinforcement member 1280 can be attached to or located proximate to a second end or top end of the valve member 1250, which can be opposite from the first end thereof, to help fix the location of the valve member 1250 and to prevent movement of the valve member 1250 due to the high water pressure inside the shoe cavity 1136.

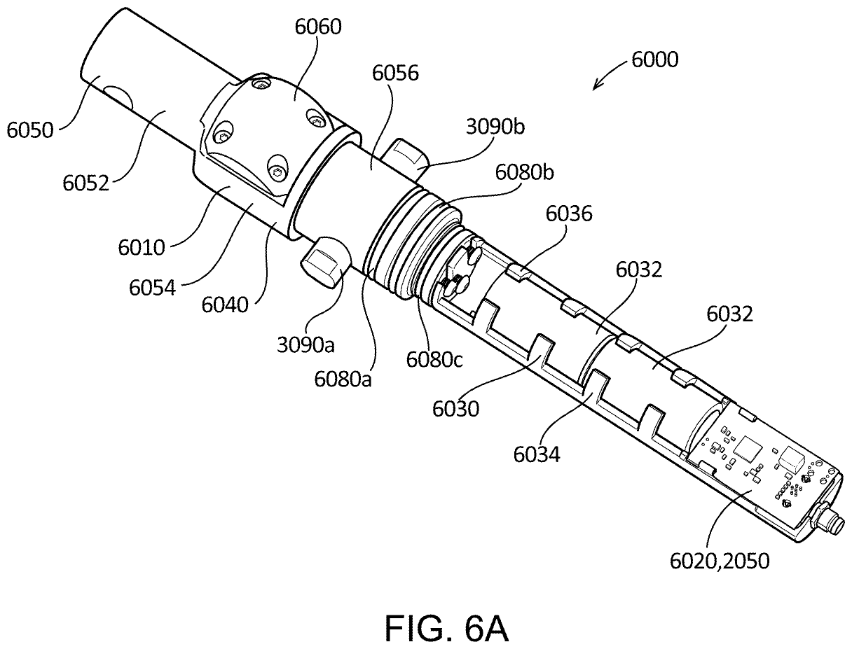

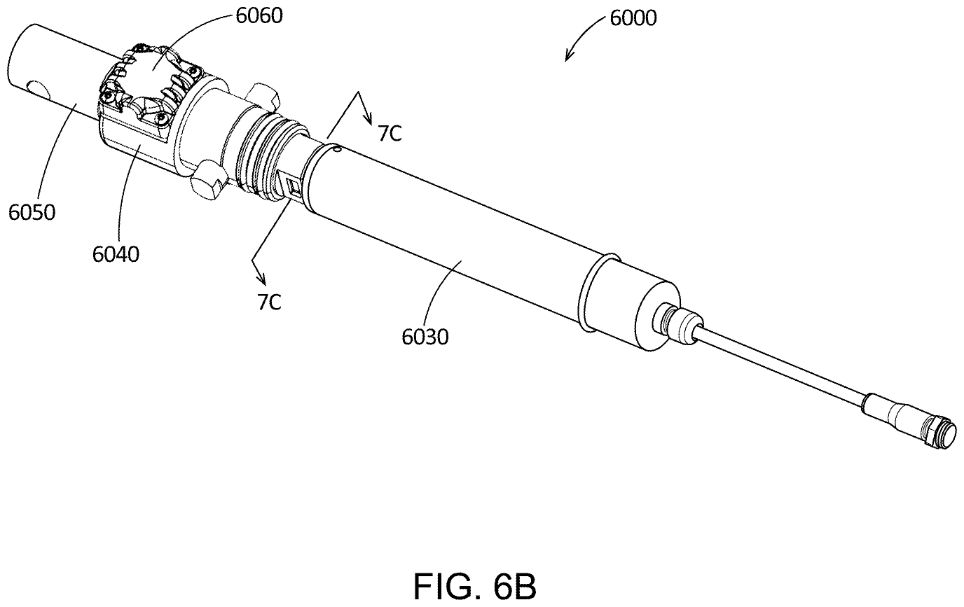

In various aspects, the hydrant 1000 can comprise a sensing device 1300. As shown, the sensing device 1300 can comprise a sensor 3010, at least one battery 1350 (which can be the same as a battery 6032 shown in FIG. 6), and an antenna 1370. The operating stem 1210 can comprise an upper stem 1212 and a lower stem 1214. The sensor 3010 can be a sensor assembly. The lower stem 1214 can comprise a lower stem top end 6000. The sensing device 1300 can be housed within the operating stem 1210 and, more specifically, the lower stem 1214. The sensing device 1300 can comprise a sensing probe 3040. In some aspects, the sensing device 1300 need not be incorporated into a hydrant 1000 and can be incorporated into another system component. In some aspects, incorporating the sensing device 1300 into the hydrant 1000—without affecting operation of the hydrant 1000—one can avoid the expense of an independent installation (e.g., of a separate sensing device) and can avoid taking equipment useful for public safety out of temporary service.

The lower stem 1214 can comprise a lower stem bottom end 3000, which can be opposite from the lower stem top end 6000 on the lower stem 1214. The lower stem 1214 can comprise a stem pipe 2000, which can join the lower stem bottom end 3000 and the lower stem top end 6000. The sensing device 1300 can be at least partly housed within the stem pipe 2000. In some aspects, as shown, the lower stem bottom end 3000 can be coupled to the stem pipe 2000 at a lower end or first end 2005 of the stem pipe 2000 and the lower stem top end 6000 can be coupled to the stem pipe 2000 at an upper end or second end 2006 of the stem pipe 2000. As shown, each of the valve member 1250, the valve retainer 1260, and the reinforcement member 1280 can comprise features allowing the sensing device 1300 to have access to the fluid in the fluid distribution system. With such access, the sensing device 1300 can sense properties of the fluid. The operating stem 1210 and, more specifically, the lower stem bottom end 3000 can comprise a hollow vessel or vein 1310 configured to expose the sensor 3010 to the fluid of the fluid distribution system whose properties are to be measured.

In some aspects, the construction and arrangement of the hydrant 1000 and components thereof including, for example and without limitation, the sensing device 1300 can be as disclosed in U.S. application Ser. No. 16/434,915, filed on Jun. 7, 2019, and issued as U.S. Pat. No. 10,968,609 on Apr. 6, 2021, or as disclosed in U.S. application Ser. No. 16/435,004, filed on Jun. 7, 2019, each of which is hereby incorporated by reference herein in its entirety. In some aspects, the hydrant 1000 can comprise a communications hub 1920 (also disclosed within U.S. application Ser. Nos. 16/434,915 and 16/435,004), which can be housed within the bonnet 1130 and can receive, process, and send elsewhere a signal received wirelessly from the sensing device 1300 via the antenna 1370. In some aspects, the connection between the sensing device 1300 and the communications hub 1920 can be a wired connection.

FIG. 2B is a sectional view of the hydrant 1000 of FIG. 1 taken from detail 2B of FIG. 1 and comprising a sensing device 1300 positioned inside a stem of the hydrant. As shown, the operating stem 1210 can connect to the valve 1220 to facilitate and, more specifically, effect actuation (e.g., opening and closing) of the valve 1220. Again, the lower barrel assembly 1020 can comprise the lower barrel 1230. In a typical arrangement in which the hydrant 1000 is a dry barrel hydrant, the hydrant 1000 can be in a state such that no water is stored in the upper barrel 1110 or the lower barrel 1230—such as when the valve 1220 is closed. The valve 1220 can be operated by the operating nut 1140 (shown in FIG. 2A) to open the valve 1220 and to thereby allow the flow of water into the lower barrel 1230 and the upper barrel 1110.

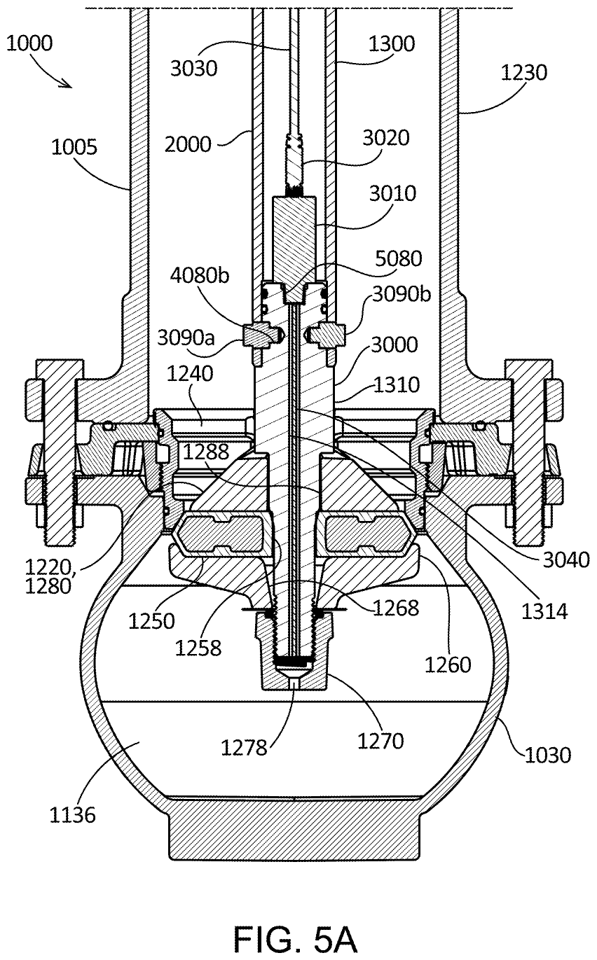

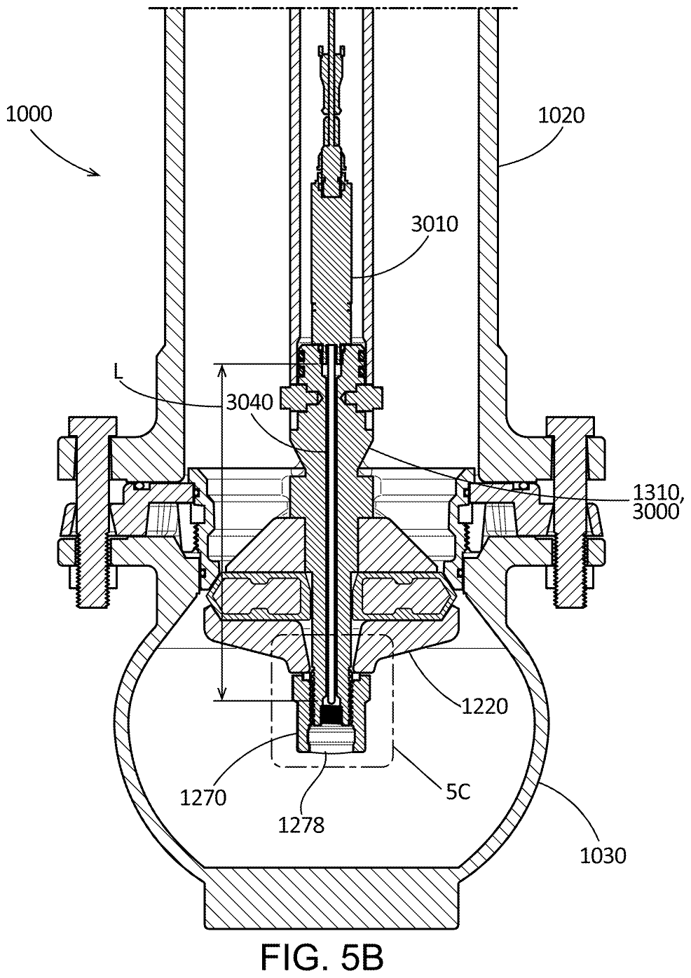

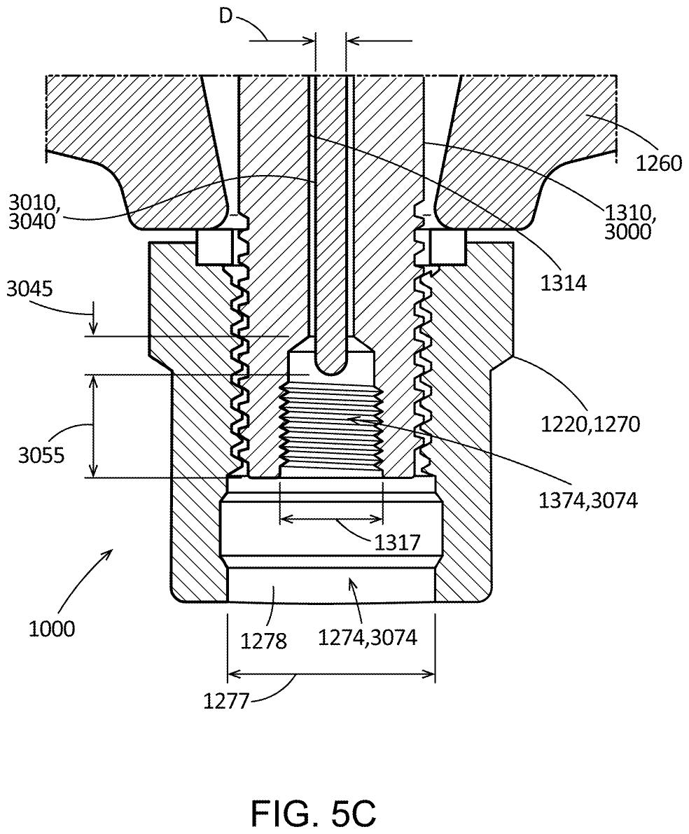

As shown, the sensing probe 3040 can be elongated. More specifically, a length L (shown in FIG. 5B) of the sensing probe 3040 can be much greater than a diameter D (shown in FIG. 5C) of the sensing probe 3040. In some aspects, the length L can be at least 10 times the diameter D. In some aspects, the length L can be at least 20 times the diameter D. In some aspects, the length L can be at least 30 times the diameter D. In some aspects, the length L can be at least 40 times the diameter D. In some aspects, the length L and the diameter D can be sized such that a first end 3043 of the probe 3040 is positioned proximate to a first end or top end of the vein 1310 and a second end or distal end 3044 of the probe 3040 is positioned proximate to a second end or bottom end of the vein 1310. The vein 1310 can define a channel 1314, which can be sized and otherwise configured to receive the probe and to allow passage of the fluid around the probe to the first end 3043 of the probe 3040. More specifically, in some aspects, the probe 3040 can extend a full length of the channel 1314 defined in the vein 1310. In some aspects, as shown, the probe 3040 can extend past a second end or bottom end of the channel 1314 defined in the vein 1310. By extending the full length of the channel 1314 or past the bottom end of the channel 1314, the probe 3040 can be more directly exposed to the fluid inside the fluid distribution system and, more specifically, to the fluid inside the shoe cavity 1136 and one or more characteristics or properties of the fluid more accurately measured thereby. By remaining within a cavity 3074 defined in the valve 1220 and, more specifically, the valve nut 1270 the sensing probe 3040 of the sensor 3010 can remain protected. As shown, a portion of the sensor 3010 and, more specifically, connecting portions thereof can be encapsulated with a cover 2060.

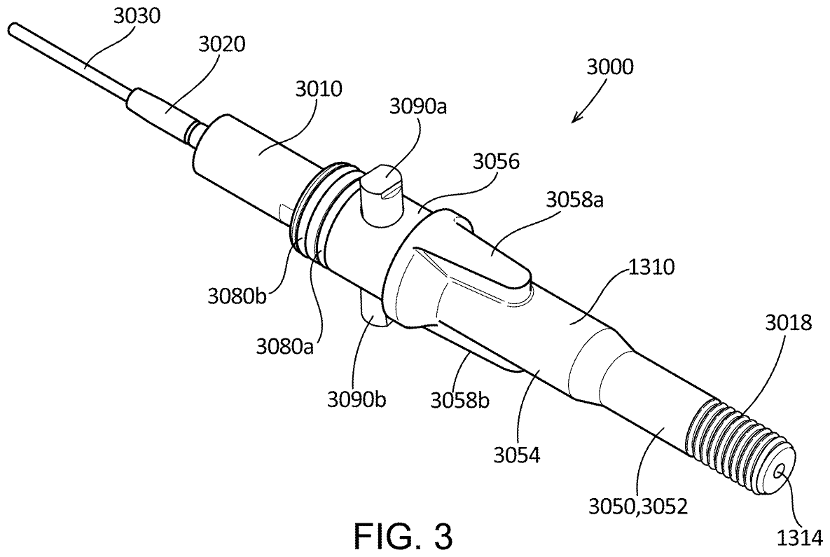

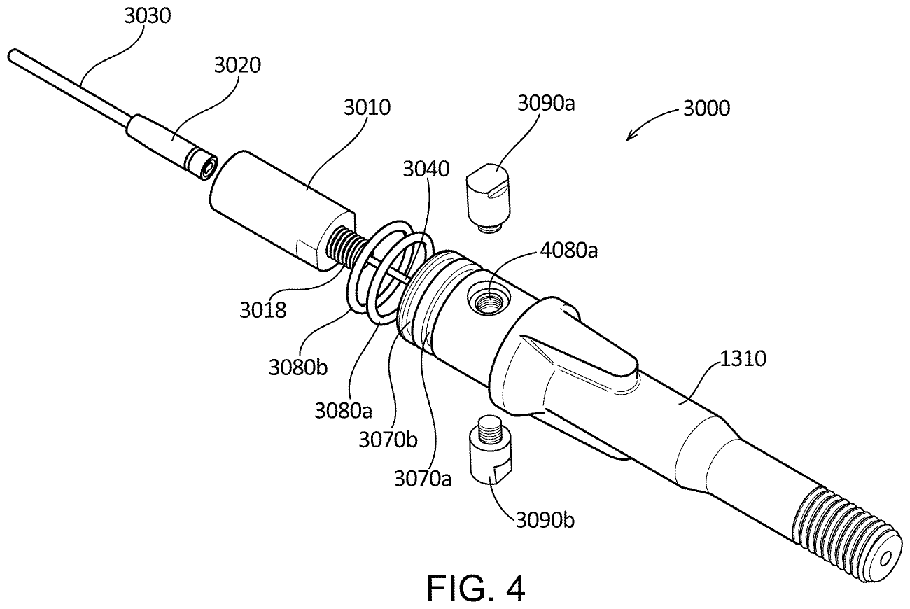

FIG. 3 is a bottom perspective view of the vein 1310 of the lower stem bottom end 3000 of the sensing device 1300 of the operating stem 1210 (shown in FIG. 2A) of the hydrant 1000 (shown in FIG. 1) in an assembled condition, and FIG. 4 is a bottom perspective view of the lower stem bottom end 3000 in an exploded or disassembled condition. As shown in FIG. 3, the lower stem bottom end 3000 of the operating stem 1210 can comprise the vein 1310. The vein 1310 can incorporate the features of a valve stem including a shaft sized to receive the valve member 1250. The sensor 3010 can be coupled to the vein 1310. A sensor connector 3020 can be coupled to the sensor 3010. A sensor wire 3030 can be coupled to the sensor connector 3020. The sensor wire 3030 can be coupled to the lower stem top end 6000 (shown in FIG. 2). A pair of O-rings 3080a,b can be sized to be received within a pair of grooves 3070a,b (shown in FIG. 4) defined proximate to a top end of the vein 1310. Again, the pair of fasteners 3090a,b can be sized to be received within the pair of bores 4080a,b (4080a shown in FIG. 4, 4080b shown in FIG. 5A) defined within the vein 1310.

As shown in FIG. 3, the vein 1310 can comprise a valve stem shaft 3050, which can be divided into a first portion 3052 and a second portion 3054. The first portion 3052 can be sized to receive any one or more of the valve member 1250 (shown in FIG. 2A), the valve retainer 1260 (shown in FIG. 2A), and the valve nut 1270 (shown in FIG. 2A). The second portion 3054 can be sized to receive the reinforcement member 1280 (shown in FIG. 2A) and can define two lobes 3058a,b for fixing a rotational position or orientation of the reinforcement member 1280 relative to the valve stem shaft 3050 and, more generally, the vein 1310. The vein 1310 can further comprise a third portion 3056, which can be sized to be received within the stem pipe 2000 and can seal against an interior surface of the stem pipe 2000 using, for example, the O-rings 3080a,b). The first portion 3052, the second portion 3054, the third portion 3056, and the lobes 3058a,b of the valve stem shaft 3050 can vary in shape and diameter as shown to more easily mate with the proper components in the proper order in a way that communicates to a technician that such assembly is proper. As shown in FIG. 4, the sensor 3010 can comprise a threaded portion 3018, which can be received within a bore 5080 (shown in FIG. 5A) of the vein 1310.

As shown, components of the hydrant 1000 such as, for example and without limitation, the valve member 1250, the valve retainer 1260, or the valve nut 1270 can be a standard component used in hydrants of the type shown. As such, the valve 1220 (shown in FIG. 2) and, more specifically, each of the valve member 1250, the valve retainer 1260, and the valve nut 1270 need not be redesigned or specially made to incorporate the lower stem bottom end 3000 and the sensing device 1300 (shown in FIG. 2B) as disclosed herein. Accordingly, an existing hydrant or a hydrant with an existing valve 1220 can be retrofitted with the sensing device 1300 and associated components. Moreover, parts of the valve 1220 and the hydrant 1000 can remain interchangeable between hydrants 1000 with and without the sensing device 1300 and associated components disclosed herein, in which case such parts can be backwards compatible with previous designs for each of the recited components.

In some aspects, the sensor 3010 is a pressure sensor for measuring a pressure of the fluid in the disclosed fluid distribution system. In other aspects, the sensor 3010 is a sensor measuring any one of a number of other fluid properties, including, for example and without limitation, temperature. In some aspects, as described in further detail below, the sensor 3010 can measure more than one fluid property and, more specifically, both pressure and temperature. The sensor 3010 can be potted with potting material configured to seal a portion of the sensor 3010 containing electronics against water intrusion.

FIG. 5A is a detail sectional view of the hydrant 1000 of FIG. 1 taken from detail 5A of FIG. 2A showing the lower stem bottom end 3000 of FIG. 3 as well as the valve 1220 and surrounding structures of the hydrant 1000. Again, the valve member 1250, which can define a member bore 1258 sized to receive the lower stem bottom end 3000, can be engaged with the valve seat 1240, thereby closing the valve 1220 as shown. Even in the closed position of the valve 1220, however, the vein 1310 and specifically the channel 1314 defined therein can allow the sensing device 1300 and specifically the sensor 3010 to nonetheless be in fluid communication with the shoe cavity 1136 with the fluid of the fluid distribution system for system monitoring purposes. In some aspects, as shown, at least a portion of the sensor 3010 can be positioned proximate to the upper end of the channel 1314 of the vein 1310. More specifically, the sensor 3010 can be positioned facing the channel 1314 of the vein 1310 to measure a property of a fluid of the fluid system. Again, as also shown, at least a portion of the sensor 3010 and, more specifically, the probe 3040 thereof can extend through the channel 1314 of the vein 1310. The valve nut 1270 can define a nut bore 1278, which can place the fluid of the fluid distribution system in fluid communication with the sensor 3010 or a portion thereof.

A retainer bore 1268 can be defined in the valve retainer 1260 and a reinforcement member bore 1288 can be defined within the reinforcement member 1280. As such, each of the valve member 1250, the valve retainer 1260, and the reinforcement member 1280 can define a bore for passage of the lower stem bottom end 3000 including the vein 1310.

In some aspects, as shown, the vein 1310 can be cylindrical or comprise cylindrical portions; in other aspects, the vein 1310 can be conical, frustoconical, or can define any one or more of a variety of shapes as desired and understood by one in the art. The vein 1310 can define a lower portion of the sensing device 1300. The stem pipe 2000 can be attached or connected to the vein 1310. In various aspects, portions of the stem pipe 2000 can in fluid communication with the vein 1310; in various aspects, portions of the stem pipe 2000 can be sealed or otherwise isolated from fluid.

FIG. 5B is a detail sectional view of the hydrant 1000 of FIG. 1 taken along line 5B-5B of FIG. 2B showing the lower stem bottom end 3000 of FIG. 3 as well as the valve 1220 of the hydrant 1000 in accordance with another aspect of the current disclosure shown also in FIG. 2B.

FIG. 5C is a detail sectional view of a bottom end of the lower stem bottom end 3000 of the hydrant 1000 of FIG. 1 taken from detail 5C of FIG. 5B. One or both of the vein 1310 and the valve nut 1270 can define a cavity 3074 as shown. More specifically, the vein 1310 can define a cavity 1374 and the valve nut can define a cavity 1274, and each of the cavities 1274,1374 can together form the cavity 3074. In some aspects, as shown, a diameter 1277 of the nut bore 1278 of the valve nut 1270 can be equal to or greater than a diameter 1317 of the vein 1310 at an end of the vein 1310. In some aspects, as shown, the diameter 1277 and the diameter 1317 can both be greater than a diameter D of the probe 3040. As shown, the probe 3040 can extend past an end of at least a narrow portion of the channel 1314 by an extension distance 3045. In some aspects, the probe 3040 can extend to become flush with or extend past the valve nut 1270 or otherwise extend to become flush with or extend past a bottom end of the operating stem 1210 and/or the valve 1220. In some aspects, the probe 3040 can be recessed from the bottom end of the operating stem 1210 and/or the valve 1220 by a recess distance 3055. The cavity 1374 of the vein 1310 can define a threaded portion as shown, which can be used to facilitate manufacturing of the sensing device 1300.

FIG. 6A is a bottom perspective view of a lower stem top end 6000 of the sensing device 1300 (shown in FIG. 2A) of the operating stem 1210 (shown in FIG. 2A) of the hydrant 1000 (shown in FIG. 2A) in an assembled condition, and FIG. 6B is a bottom perspective view of the lower stem top end 6000 of the operating stem 1210 of the hydrant 1000 of FIG. 1 in an assembled condition in accordance with another aspect of the current disclosure shown also in FIG. 2B. The lower stem top end 6000 can comprise a top stem housing 6010, a sensor controller or sensor printed circuit board (PCB) 6020, and a battery pack 6030. The battery pack 6030 can comprise at least one of the batteries 6032 and a battery container 6034. The battery container 6034 can comprise a battery cage 6036. The sensor printed circuit board (PCB) 6020 can be in electrical communication with the sensor 3010 of the lower stem bottom end 3000 and with the battery pack 6030 and can be housed and sealed within the battery container 6034. The sensor PCB 6020 can further comprise a clock 2050 in each of the sensing device 1300 and the communications hub 1920 (shown in FIG. 2A) for gathering, synchronization, and reporting of collected data.

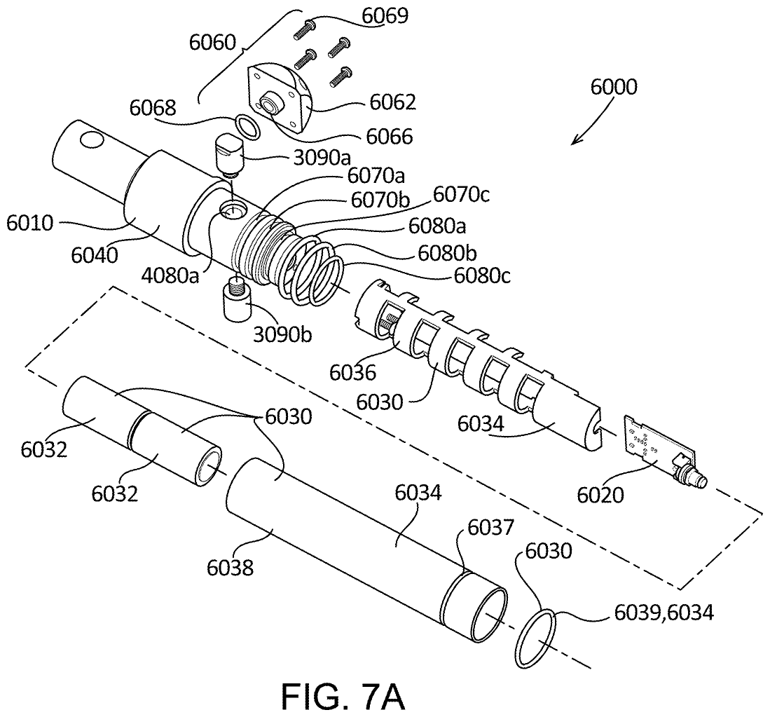

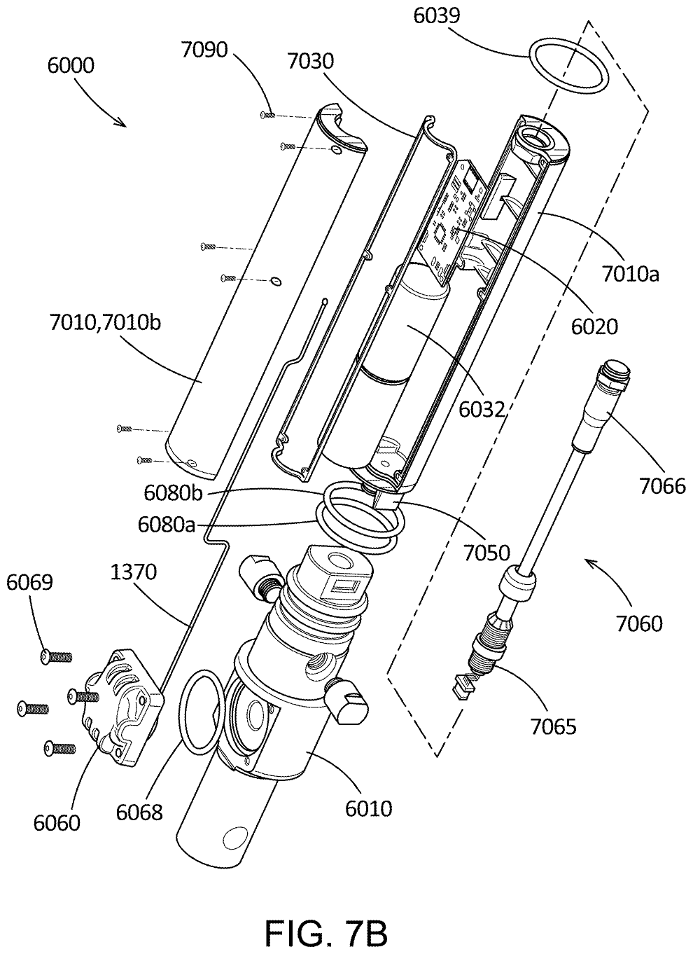

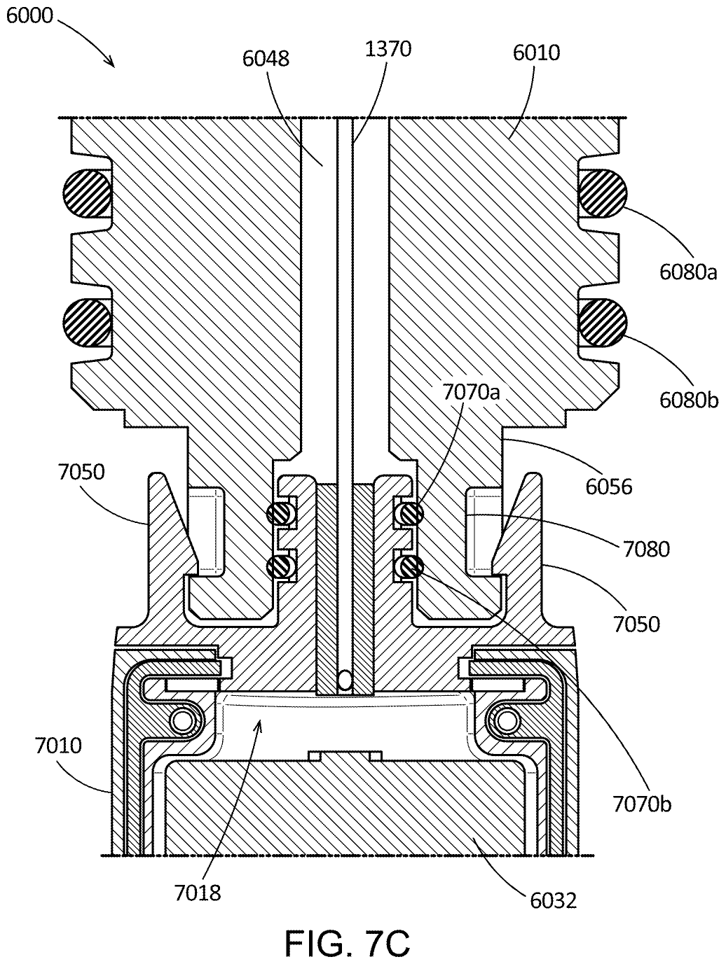

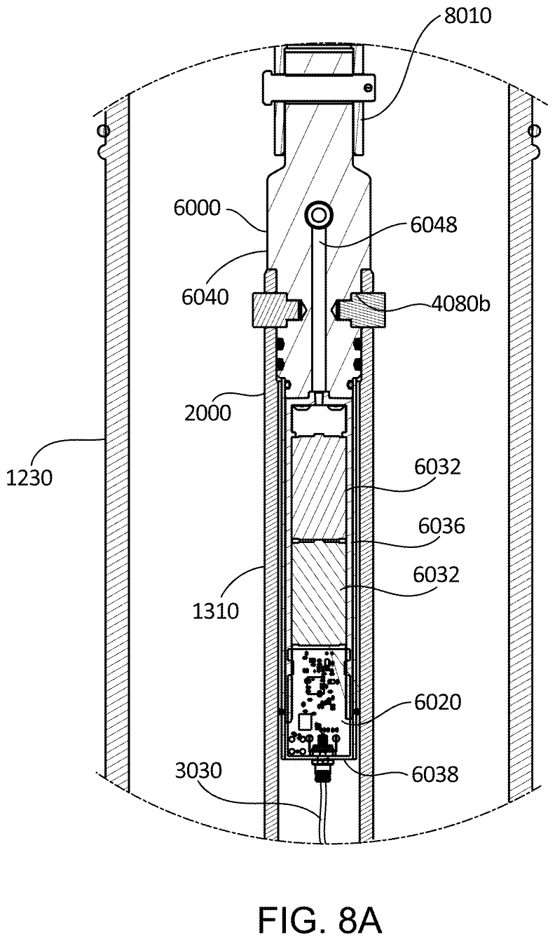

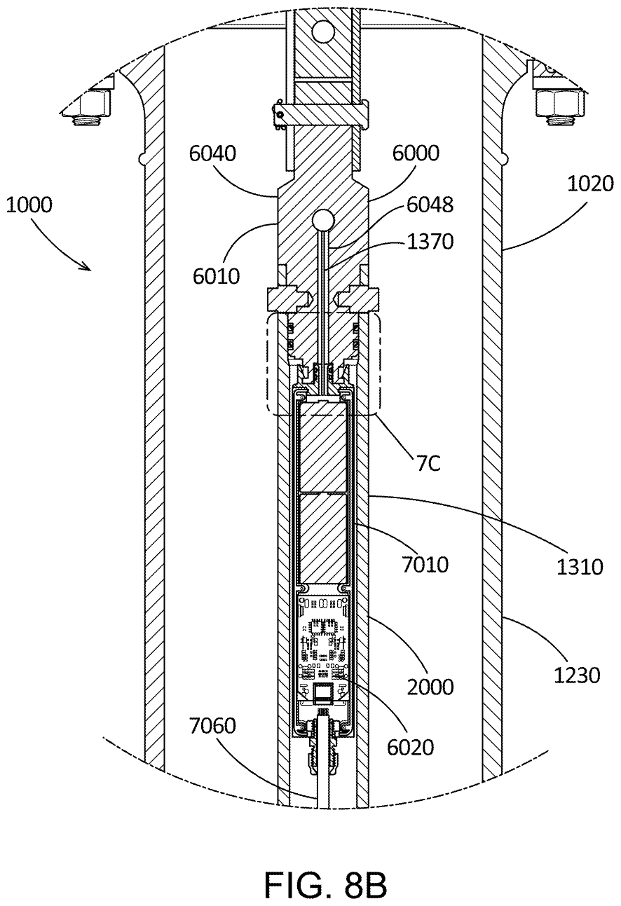

As also shown in FIG. 6A, the top stem housing 6010 can comprise a fitting 6040, the antenna 1370 (shown in FIG. 2A), and an antenna cover assembly 6060. The top stem housing 6010 can further comprise three O-rings 6080a,b,c sized to be received within grooves 6070a,b,c (shown in FIG. 7A) defined proximate to a bottom end of the fitting 6040, and a pair of fasteners 3090a,b can be sized to be received within a pair of bores 4080a,b (4080a shown in FIG. 7, 4080b shown in FIG. 8A) defined within the fitting 6040. In some aspects, the fasteners 3090a,b can be shoulder screws. In other aspects, the fasteners 3090a,b can be another type of fastener. The antenna 1370 can be in electrical communication with the sensor 3010 (shown in FIG. 4) and also in wireless communication with a communications hub 1920 (shown in FIG. 2A). The fitting 6040 can further define a stem pipe adaptor shaft 6050, which can comprise one or more of a first portion 6052 configured to join the lower stem 1214 (shown in FIG. 2A) comprising the sensing device 1300 (shown in FIG. 2A) to the upper stem 1212 (shown in FIG. 2A) via a stem coupling 8010 (shown in FIG. 8), a second portion 6054 receiving the antenna cover assembly 6060, and a third portion 6056, which can be sized to be received within the stem pipe 2000 and seal against an interior surface of the stem pipe 2000 (using, for example, the O-rings 6080a,b).

FIG. 7A is a bottom exploded perspective view of the lower stem top end 6000 in a disassembled condition, and FIG. 7B is a bottom exploded perspective view of the lower stem top end 6000 of FIG. 6B in a disassembled condition in accordance with another aspect of the current disclosure shown also in FIG. 2B. As shown in FIG. 7A, the antenna cover assembly 6060 can comprise a cover 6062, a seal 6068, and fasteners 6069 for securing the cover 6062 via engagement with bores defined in the fitting 6040. As shown, the seal 6068 can be an O-ring and can in any case be configured to seal against water intrusion into a cavity housing the antenna 1370. The cover 6062 can define a pocket 6066 in an interior surface for receiving a tip of the antenna 1370 (shown in FIG. 2A).

The battery pack 6030 can comprise at least one of the batteries 6032 and a battery container 6034. The battery container 6034 can comprise one or more of a battery cage 6036, a battery casing 6038, and an O-ring 6039. The battery 6032 can be positioned inside the battery cage 6036, which can be received within the battery casing 6038, an end of which can be received within the O-ring 6039 to seal between the stem pipe 2000 and the battery casing 6038 of the battery container 6034. More specifically, the O-ring 6039 can be received within a casing groove 6037 of the battery casing 6038. The battery 6032 and the battery pack 6030 generally can be in electrical communication with the sensor 3010 to power the sensor 3010.

The sensor PCB 6020 (and, similarly, a hub PCB used within the communications hub 1920) can be attached to the surrounding structure by fasteners. In various aspects, the fasteners can be any fastener known in the art, including glue, welding, nails, mechanical locks, and mechanical fasteners, among others. In various aspects, the sensor PCB 6020 and the hub PCB can comprise various arrangements of electronic components. In various aspects, the sensor PCB 6020 and the hub PCB can be eliminated by circuitry. The sensor PCB 6020 in the current aspect can be in electrical communication with the sensor 3010.

The battery container 6034, which can comprise the battery cage 6036, can be a semi-rigid container to hold the one or more batteries 6032. The battery container 6034 can be substantially laddered having a plurality of bands arranged to alternate location on sides of the battery container 6034. As a result, the battery container 6034 can serve as a rigid or semi-rigid container in various aspects for a plurality of batteries 6032. In the current aspect, the battery container 6034 can contain at least two batteries 6032, although any number of batteries can be present in other aspects. The battery container 6034 can be a part of the sensing device 1300.

As shown in FIG. 7B, the lower stem top end 6000 can comprise any one or more of the aforementioned components of the assembly of FIG. 7A. In some aspects, the lower stem top end 6000 can comprise a housing 7010, which can be watertight and can define a cavity 7018 (shown in FIG. 7C) configured to receive electrical components or assemblies therein. The housing 7010 can comprise a first portion 7010a, a second portion 7010b, a gasket or seal 7030, and one or more fasteners 7090, each of which can comprise a screw, for assembling the second portion 7010b to the first portion 7010a. Each of the first portion 7010a and the second portion 7010b can be formed from a rigid or nondeformable material. Each of the first portion 7010a and the second portion 7010b can be formed from a polymer material such as, for example and without limitation, a polycarbonate and ABS blend. The seal 7030 can be formed from a deformable or elastic material. The sensing device 1300 can comprise a connector 7060 defining a first end 7065 and a second end 7066. Either or both of the first end 7065 and the second end 7066 can define a watertight connection. More specifically, either or both of the first end 7065 and the second end 7066 can define an IP68 minimum ingress protection rating. The watertight construction of the lower stem top end 6000, including the connection between the first portion 7010a and the second portion 7010b and the connection with the connector 7060, can eliminate the need for potting in any of the internal electrical components or assemblies of the lower stem top end 6000 including, for example and without limitation, the sensor PCB 6020. More generally, the watertight construction of the sensing device 1300 (shown in FIG. 2B) including the connection between the stem pipe 2000 and each of the lower stem top end 6000 and the lower stem bottom end 3000 and, more generally, the lower stem 1214 can eliminate the need for potting in any of the internal electrical components or assemblies of the lower stem top end 6000 or even in the sensor 3010.

FIG. 7C is a sectional view of the lower stem top end 6000 of FIG. 6B taken along line 7C-7C of FIG. 6B and, alternatively, detail 7C of FIG. 8B. The third portion 6056 of the top stem housing 6010 can comprise one or more detents 7080, and the housing 7010 can comprise one or more tabs 7050, each of which can comprise a snap-fit hook configured to rotate about a base defining a plastic hinge. A connection between the housing 7010 and the top stem housing 6010 can thereby be a snap-fit connection. The connection between the housing 7010 and the top stem housing 6010 can be sealed with one or more seals 7070a,b, which can be O-rings. The one or more seals 7070a,b can seal an antenna cavity 6048 configured to receive the antenna 1370.

FIG. 8A is a detail sectional view of the hydrant 1000 showing the lower stem top end 6000 and surrounding structure of the sensing device 1300, and FIG. 8B is a detail sectional view of the hydrant 1000 of FIG. 1 taken from detail 8 of FIG. 2A showing the lower stem top end 6000 of FIG. 6B. As shown, the fitting 6040 of the lower stem top end 6000 can define the antenna cavity 6048 at an upper end and the connector 7060. The connector 7060 can comprise the sensor wire 3030 (shown in FIG. 8A) and can be in electrical communication with both the sensor PCB 6020 and the sensor 3010 (shown in FIG. 5A) as fully assembled.

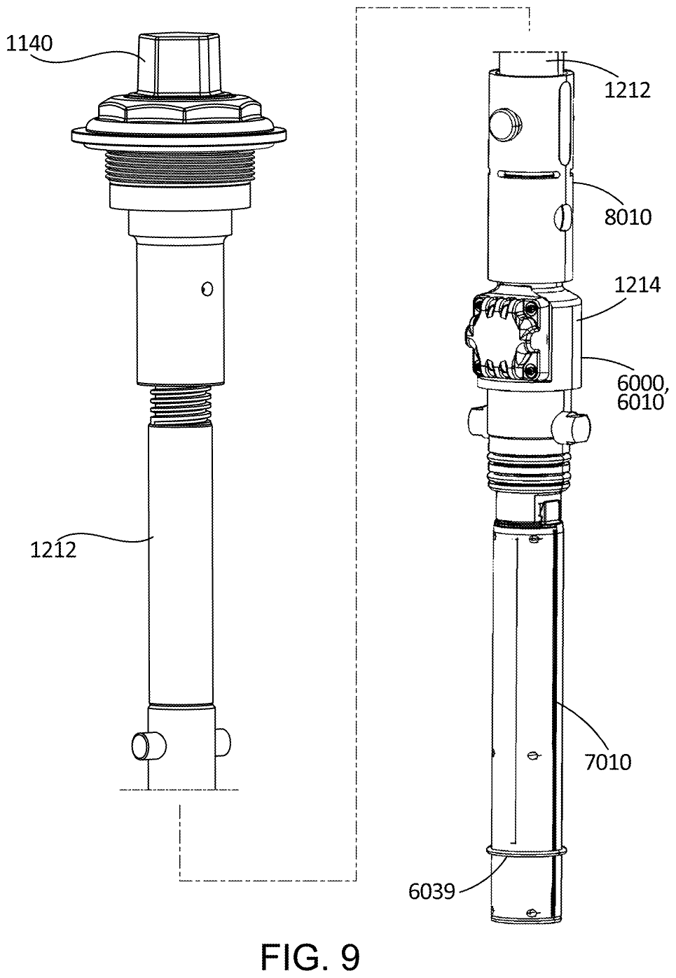

FIG. 9 is a partial side perspective view of the operating stem 1210 of the hydrant 1000 extending from the operating nut 1140 of the hydrant 1000 and the upper stem 1212 and the lower stem top end 6000. As shown, the stem coupling 8010 can join the upper stem 1212 to the lower stem 1214.

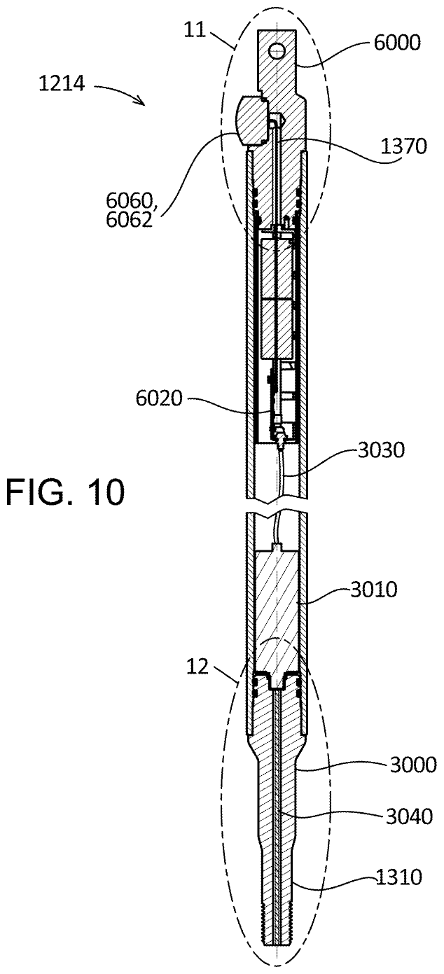

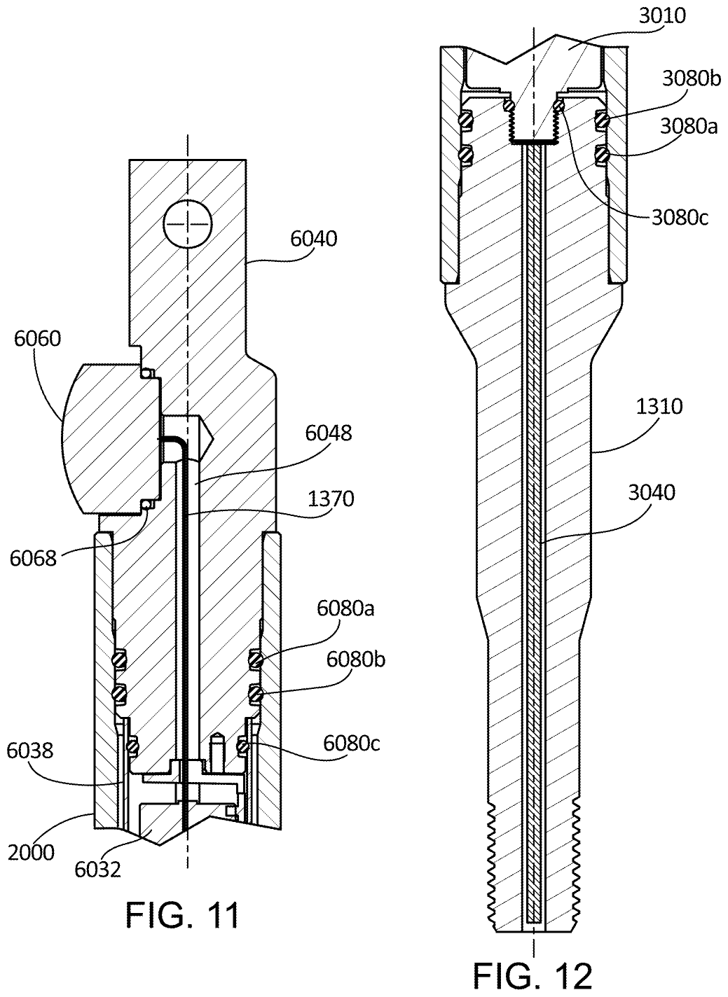

FIGS. 10-12 are sectional views of the lower stem 1214 of the operating stem 1210 in accordance with another aspect of the current disclosure showing the relationship between the previously introduced components. The antenna 1370 can be a near-field communication antenna for close-range wireless communications such as using, for example and without limitation, a low-power radio frequency (RF) communication technology such as BLUETOOTH® communications technology. Accordingly, the sensing device 1300 can comprise a radio, which can itself comprise any one or more of the sensor 3010, the sensor PCB 6020, the battery container 6034 or any portion thereof, and the antenna 1370. As shown, each portion of the sensing device 1300 except for a surface of the sensor 3010 in fluid communication with the fluid, a surface of the channel 1314, and an exposed outer surface of the housing of the lower stem 1214 can be completely isolated from fluid communication with any fluid surrounding the sensing device 1300. As shown in FIG. 12, an O-ring 3080c can seal a joint between the sensor 3010 and the vein 1310 against fluid intrusion from the channel 1314.

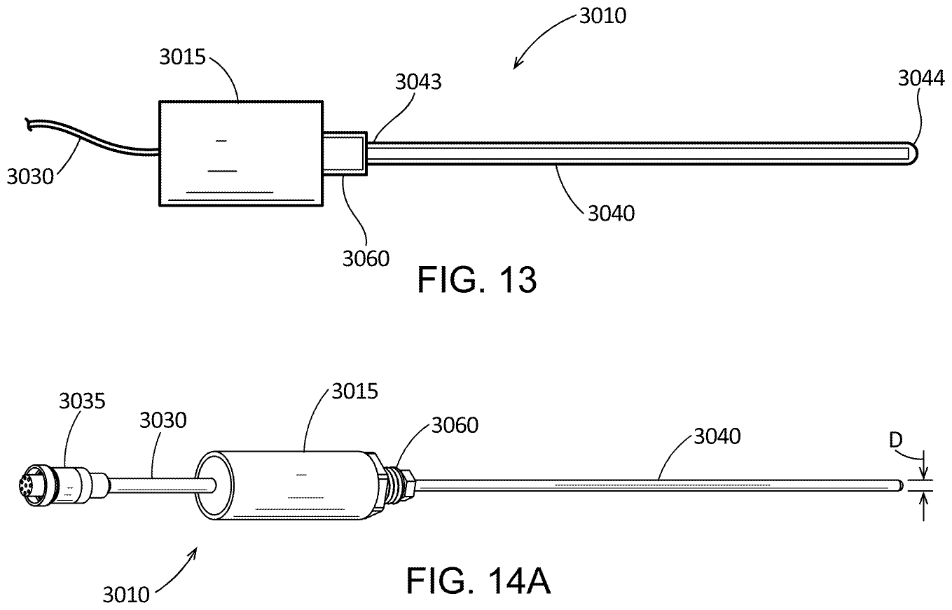

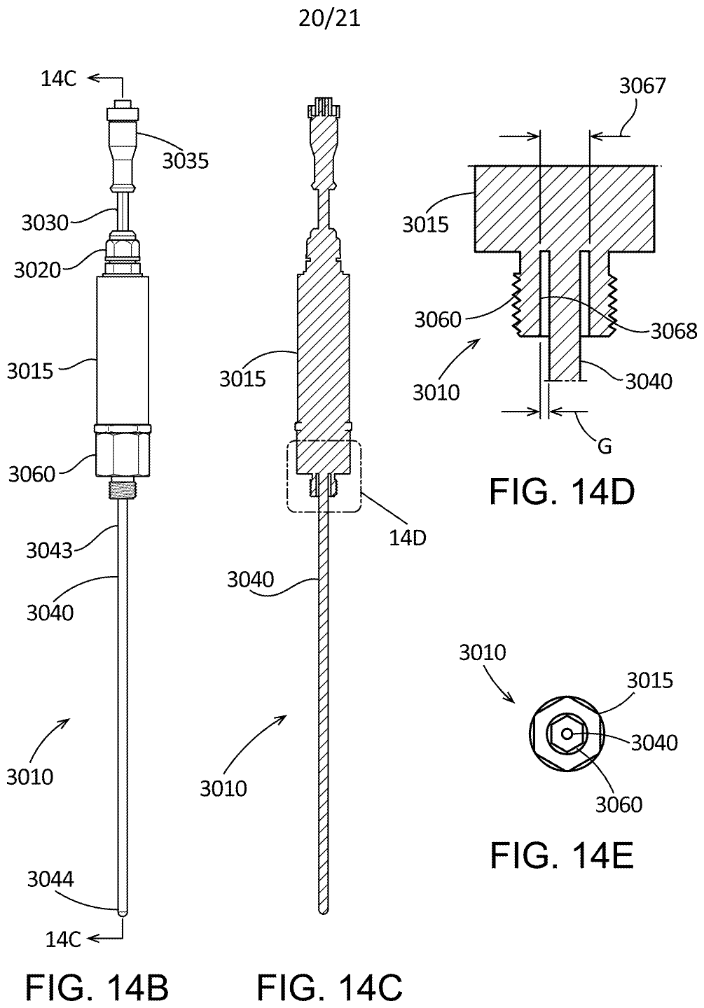

FIG. 13 is a side view of the sensor 3010 of the sensing device 1300 of FIG. 2B in accordance with another aspect of the current disclosure. The sensor 3010 of the sensing device 1300 can comprise a sensor connector 3060, which can facilitate or enable coupling of the sensor 3010 to the hydrant 1000 and, more specifically, the vein 1310 (shown in FIG. 2A). One or both of the sensor connector 3060 and the sensor connector 3020 (shown in FIG. 14B) can comprise a threaded portion. The sensor 3010 can comprise a housing 3015. The sensor 3010 can comprise a pressure sensing element or pressure sensor, which can be housed within or proximate to the sensor connector 3060. The sensor 3010 can comprise a temperature sensing element or temperature sensor, which can be housed within the probe 3040. The pressure sensor can be positioned proximate to the first end 3043 of the probe 3040 and, more specifically, between the temperature sensor and the housing 3015. In some aspects, the pressure sensor can be recessed up inside the channel 1314 (shown in FIG. 2B) of the vein 1310 (shown in FIG. 2B). The temperature sensor can be positioned proximate to or can extend to the second end 3044 of the probe 3040 and can be flush with or extrude beyond the channel 1314 (as shown in FIG. 5C). The sensor 3010, by measuring two characteristics of the fluid, can be a dual sensor.

According to Pascal's law or principle, named after Blaise Pascal, a change in pressure at any point in a contained incompressible fluid—and the compressibility of water and many other fluids is low enough to disregard in a measurement environment such as present here—is transmitted throughout the fluid such that the fluid exerts the same pressure throughout the container regardless of its shape. In a hydrant, the relevant “container” can be the space occupied by the fluid, which includes the shoe cavity 1136 and the channel 1314 and, more specifically, the small gap between the probe 3040 and the channel 1314, at least when the valve 1220 is closed. So the pressure of the fluid can be accurately measured whether the pressure sensor extends into the shoe cavity 1136 (shown in FIG. 2A) or is recessed deep into the channel 1314 of the lower stem bottom end 3000, even when only a small volume of the fluid is able to reach the pressure sensor. Temperature measurement, in contrast, is more sensitive to the location of measurement. A more direct measurement of a fluid temperature, e.g., extending the temperature sensor via the probe 3040 into an area beyond the channel 1314, can result in a more accurate temperature measurement. In contrast, a more indirect measurement of the fluid temperature can introduce inaccuracies if the separation effectively results in the temperature sensor being essentially insulated from the fluid being monitored, even if some of the fluid can reach the temperature sensor. Moreover, a more direct temperature measurement, such as disclosed herein, can result in a faster response time. In other words, fluctuations in temperature can be more quickly sensed.

The housing 3015 of the sensor 3010 can comprise—and seal against fluid penetration—a signal processing element, which can perform preliminary signal processing and can send the signals (e.g., pressure and temperature) to the sensor PCB 6020 (shown in FIG. 6) of the sensing device 1300. With its compact design, the sensing device 1300 can fit inside a variety of hydrants such as the Centurion model hydrants and B-50-B models hydrants available from Mueller Water Products, Inc. or its affiliates. Again, in some aspects, the sensing device 1300 can fit inside other structures (e.g., various valves or other components of the fluid distribution system) and need not be incorporated into the hydrant 1000 and can measure multiple parameters or characteristics of a fluid by changing out the sensor to a different type of sensor.

FIG. 14A is a side perspective view of the sensor 3010 of the sensing device 1300 of FIG. 2B in accordance with another aspect of the current disclosure, FIG. 14B is a side view of the sensor 3010 of FIG. 14A in accordance with another aspect of the current disclosure, FIG. 14C is a sectional view of the sensor 3010 of FIG. 14A taken along line 14C-14C of FIG. 14B (and not showing the internal components or other structure), FIG. 14D is a detail sectional view of the sensor 3010 of FIG. 14A taken from detail 14D of FIG. 14C, and FIG. 14E is an end view or bottom view of the sensor 3010 of FIG. 14A. As shown, the probe 3040 can be cylindrical or comprise cylindrical portions.

Specifications of the pressure sensor can comprise, for example and without limitation, a 0-250 PSI pressure range, a 12C and analog output, and ±1 PSI accuracy at 0-40° C. Specifications of the temperature sensor can comprise, for example and without limitation, a 0-40° C. temperature range, a 12C output, ±1° C. accuracy across the temperature range, and the length L measuring 8 in. (approximately 203 mm). The diameter D of the probe can be 0.156 inches (approximately 4.0 mm). Specifications of the sensing device 1300 can comprise a G ¼ port (e.g., at the sensor connector 3060), a one-meter-long sensor wire 1330, and an 8-pin female waterproof connector (e.g., at a termination connection 3035 of the sensor wire 3030). In some aspects, the termination connection 3035 can be removably secured to another portion of the sensing device 1300 of the hydrant 1000 without tools. In other aspects, the specifications can be outside of these ranges (e.g., the pressure range can extend to 3000 PSI or greater). As shown in FIG. 14D, a space between the probe 3040 and an interior bore 3068 of a threaded portion of the sensor connector 3060 can define a gap G through which the fluid of the fluid distribution system can be received and sensed by the pressure sensor, which can be housed within the sensor 3010 and, more specifically, within the housing 3015. The interior bore 3068 can define a diameter 3067, which can measure 0.25 inches (approximately 6.4 mm). The gap G, which can measure about or at least 0.047 inches (approximately 1.2 mm) can form an annular shape around the probe 3040. One or more components of the sensor 3010 including, for example, the housing 3015 can be formed from metal. More specifically, one or more components of the sensor 3010 can be formed from stainless steel or another non-corrosive and heat-conductive material (at least during use).

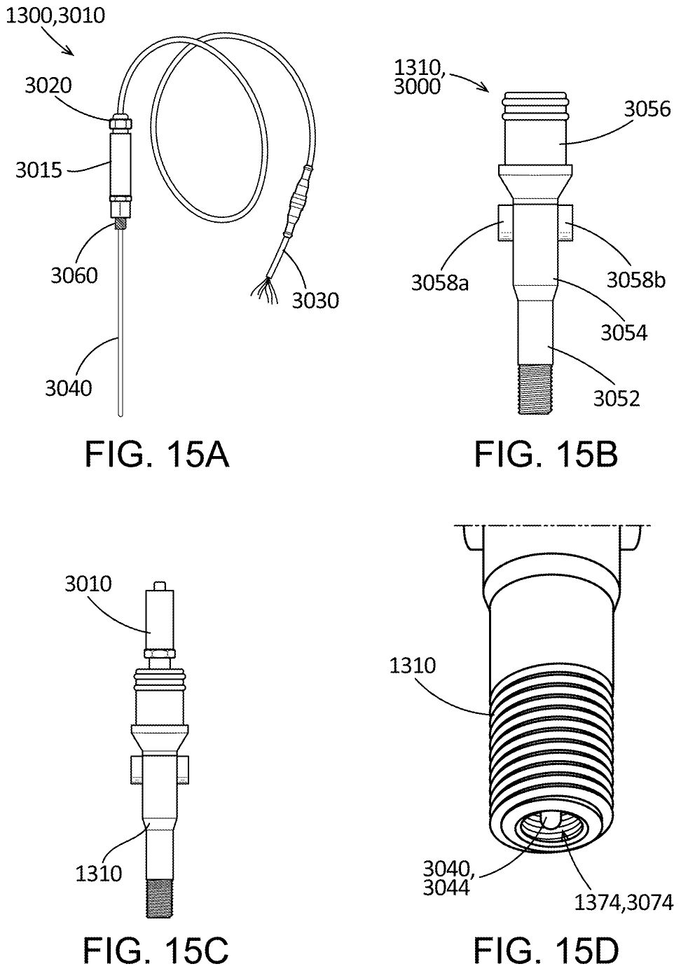

FIG. 15A is a side perspective view of the sensor 3010 of the sensing device 1300 of FIG. 2B in accordance with another aspect of the current disclosure. Again, the sensor 3010 of the sensing device 1300 can comprise the sensor connector 3060, which can comprise the threaded portion as shown. The sensor wire 3030 can extend as long as necessary to be able to reach the lower stem top end 6000 (shown in FIG. 2A) and can terminate as bare wire or in the termination connection 3035 (shown in FIG. 14A).

FIG. 15B is a side perspective view of the operating stem 1210 (shown in FIG. 2A) and, more specifically, the lower stem bottom end 3000 and the vein 1310 of FIG. 3 in accordance with another aspect of the current disclosure.

FIG. 15C is a side perspective view of the sensor 3010 of FIG. 15A assembled to the vein 1310 of FIG. 15B showing the second end 3044 (shown in FIGS. 14B and 15D) of the probe 3040 positioned within the cavities 1374,3074 (shown in FIGS. 5C and 15D).

FIG. 15D is an end perspective view or bottom perspective view of the assembly of FIG. 15C.

A method of manufacturing the hydrant 1000 and, more specifically, the sensing device 1300 can comprise aligning the housing 3015 and the probe 3040 of the sensor 3010 with the channel 1314 (shown in FIG. 2B) of the vein 1310. The method can comprise inserting the sensor 3010 and, more specifically, the probe 3040 into the channel 1314 of the vein 1310. The method can comprise securably engaging a sensor connector 3060 of the sensor 3010 with the vein 1310. The method can comprise causing the second end 3044 of the probe 3040 to reach and occupy the cavities 1374,3074. The method can install assembling one or more of the other components of the lower stem bottom end 3000 to the vein 1310. The method can install assembling one or more of the components of the lower stem top end 6000. The method can install assembling the lower stem bottom end 3000 to the stem pipe 2000. The method can install assembling the lower stem top end 6000 to the stem pipe 2000. The method can install assembling the sensing device 1300 to the valve 1220. The method can install assembling the sensing device 1300 to the upper stem 1212 to form the operating stem 1210.

A method of measuring a characteristic of a fluid inside the fluid distribution system can comprise exposing the fluid to the sensor 3010, which can be at least partially received within the vein 1310. The method can comprise receiving the fluid inside the vein 1310. The method can comprise receiving a fluid inside the channel 1314 of the vein 1310. The method can comprise receiving the fluid inside the vein 1310. The method can comprise receiving a fluid inside the channel 1314 of the vein 1310 of the operating stem 1210 of the hydrant 1000 at a vertical position below the valve 1220 and below the valve member 1250.

More generally, a method of monitoring a fluid inside the fluid distribution system can comprise measuring more than one characteristic of the fluid. The method of monitoring the fluid can comprise measuring at least the pressure and the temperature of the fluid. The method of monitoring the fluid can comprise measuring a first characteristic of the more than one characteristic of the fluid at a first location, e.g., at or above a first end 3043 of the probe 3040. The method can further comprise measuring a second characteristic of the more than one characteristic of the fluid at a second location that is different from the first location, e.g., at or around the second end 3044 of the probe 3040.

The method can further comprise recording data corresponding to one or more characteristics of the fluid such as, for example and without limitation, fluid pressure with the sensing device 1300. In other aspects, the sensor 3010 of the sensing device 1300 can comprise, at least in part, one or more of a variety of sensors known in the art, including pressure, temperature, salinity, purity, and various other sensing types. The method can further comprise transmitting the data to the antenna 1370. The method can further comprising wirelessly transmitting the data to a second antenna 1944 in wireless communication with the sensing device 1300. The method can further comprise powering the sensing device 1300 with the at least one battery 6032.

A method of processing measurements of the fluid inside the fluid distribution system can comprise receiving data wirelessly into the communications hub 1920 from the sensing device 1300 of the hydrant 1000 and transmitting the data to the second antenna 1944. Transmitting the data to the second antenna 1944 can comprise transmitting the data through the flange 1910 of the hydrant 1000 via the plug 1960 formed from a non-metallic material. The method can further comprise transmitting the data wirelessly from the second antenna 1944 to the network. The method can further comprise synchronizing the data by use of the clock 2050 in each of the sensing device 1300 and the communications hub 1920.

A method of using the data can comprise monitoring the data on a dashboard available to technicians and others responsible for maintenance and support of the fluid distribution system, the dashboard configured to show data for each of the measured characteristics of the fluid being transported by the system.

The hydrant 1000 can be equipped with apparatus sufficient to sense water flow characteristics. The hydrant 1000 can be equipped with apparatus sufficient to communicate from the hydrant 1000 to outside nodes of a network. The hydrant 1000 can be equipped with apparatus sufficient to communicate from one location within the hydrant 1000 to another location within the hydrant 1000 for repeating outside the network. In various aspects, the hydrant 1000 can communicate sensed data from the water flow. One of skill in the art would understand that the disclosed hydrant 1000 provides but a few exemplary aspects that can be implemented in many ways with sufficient knowledge and skill in the art.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A sensing device for a hydrant in a fluid distribution system, the sensing device comprising:
a housing configured to define a portion of an operating stem of the hydrant;
a vein connected to the housing, the vein defining a channel extending from a lower end of the vein to an upper end of the vein; and
a sensor received at least partly and within the channel of the vein and configured to measure at least two properties of a fluid configured to be distributed by the fluid distribution system.

2. The sensing device of claim 1, further comprising an antenna in communication with the sensor and secured to the housing.

3. The sensing device of claim 1, further comprising a sensing probe.

4. The sensing device of claim 3, wherein the sensor further comprises a pressure sensing element and a sensor connector, the sensor connector configured to connect the sensor to the vein, the sensor defining a gap between the sensing probe and the sensor connector, the gap placing the pressure sensing element of the sensor in fluid communication with the channel of the vein.

5. The sensing device of claim 1, wherein the sensor comprises:
a housing; and
a sensing probe extending from the housing, the sensing probe comprising a sensing element configured to measure at least one of the at least two properties of the fluid.

6. The sensing device of claim 5, wherein the sensing probe defines a length measuring at least 10 times a diameter of the sensing probe.

7. The sensing device of claim 5, wherein the sensing element is a temperature sensing element.

8. The sensing device of claim 7, wherein the sensor further comprises a pressure sensing element.

9. The sensing device of claim 7, wherein:
the sensing probe defines a first end proximate to the housing and a second end distal from the housing; and
the temperature sensing element is positioned proximate to or in contact with a distal end of the sensing probe.

10. A hydrant for a fluid distribution system, the hydrant comprising:
a hydrant body defining an interior cavity;
a valve located in sealable communication with the hydrant body, the interior cavity in fluid communication with a shoe cavity of the system when the valve is open, the valve configured to seal the interior cavity of the hydrant from the shoe cavity when the valve is closed;
a stem secured to the valve, positioned at least partly inside the interior cavity of the hydrant, the stem configured to open and close the valve, the stem comprising the vein; and
the sensing device of claim 1.

11. The hydrant of claim 10, wherein the sensing device further comprises at least one battery in communication with the sensor.

12. The hydrant of claim 10, wherein the sensor comprises a sensing probe defining a first end and a second end, a first characteristic being pressure and the second characteristic being temperature, the sensor comprising a pressure sensing element at the first end of the sensing probe and a temperature sensing element at the second end of the sensing probe positioned opposite the first end.

13. The hydrant of claim 10, further comprising a valve nut configured to maintain a position of components of the valve, the sensing probe extending at least partially through the valve nut.

14. A sensor assembly comprising:
a housing;
a pressure sensing element coupled to the housing;
a temperature sensing element coupled to the housing; and
an antenna in communication with each of the pressure sensing element and the temperature sensing element and positioned within the housing;
wherein the sensor assembly is configured to be received within an interior cavity of a hydrant.

15. The sensor assembly of claim 14, wherein the housing defines a first portion and a second portion sealably and removably joined to the first portion.

16. The sensor assembly of claim 14, wherein the housing is a first housing, the sensor assembly further comprising a second housing comprising a sensor PCB and configured to receive at least one battery in communication with the pressure sensor and the temperature sensor.

17. The sensor assembly of claim 16, wherein the second housing is secured to the first housing with a tab, the second housing comprising the tab and forming a snap-fit connection with the first housing.

18. A method comprising:
measuring a first characteristic of a fluid inside a hydrant of a fluid distribution system with a sensing device, the sensing device comprising:
a vein defining a channel; and
a sensor comprising:
a first sensing element in fluid communication with the channel of the vein;
a second sensing element in fluid communication with the channel of the vein; and
at least one battery in communication with the sensor;
measuring a second characteristic of the fluid with the sensing device; and
transmitting data corresponding to the first characteristic and the second characteristic of the fluid from the sensor.

19. The method of claim 18, wherein the first characteristic is pressure and the second characteristic is temperature.

20. The method of claim 18, wherein the sensing device further comprises an antenna in communication with the sensor, the method further comprising transmitting data corresponding to the first characteristic and the second characteristic of the fluid from the sensor to the antenna.
